(19) United States
(12) Patent Application Publication
(10) Pub. No.: US 2024/0281948 A1
(43) Pub. Date: Aug. 22, 2024

(54) IMAGE PROCESSING DEVICE, AND IMAGE PROCESSING METHOD

(71) Applicant: Mitsubishi Electric Corporation, Tokyo (JP)

(72) Inventors: Osamu NASU, Tokyo (JP); Keiichi SHIRASUKA, Tokyo (JP)

(73) Assignee: Mitsubishi Electric Corporation, Tokyo (JP)

(21) Appl. No.: 18/567,032

(22) PCT Filed: Jun. 18, 2021
(86) PCT No.: PCT/JP2021/023162

§ 371 Date: Dec. 5, 2023

(51) Int. Cl. G06T 7/00; G06T 7/11; G06T 7/73

(52) U.S. Cl. CPC G06T 7/0002; G06T 7/11; G06T 7/73; G06T 2207/10016; G06T 2207/20081

(57) ABSTRACT

An image processing device includes an acquisition unit that acquires an image and a testing learned model for testing a target object of a test, an analysis generation unit that analyzes whether the target object of the test is included in the image or not by using the image and generates an analysis result indicating that the image is appropriate as an image used for the test when the target object is included in the image, and a testing unit that tests the target object included in the image by using the image and the testing learned model when the analysis result indicates that the image is appropriate as an image used for the test.

### TECHNICAL FIELD

The present disclosure relates to an image processing device, an image processing method and an image processing program.

### BACKGROUND ART

As a method of testing a target object, there is a method of testing the target object by using an image including the target object and a learned model. To generate the learned model, it is necessary to prepare a great amount of images as learning data. Here, a method without preparing a great amount of images has been proposed (see Patent Reference 1).

### PRIOR ART REFERENCE

### Patent Reference

Patent Reference 1: Japanese Patent Application Publication No. 2020-106935

### SUMMARY OF THE INVENTION

### Problem to be Solved by the Invention

Incidentally, when the learned model for executing the test is used, the target object needs to be included in the image. For example, in cases where an image capturing device is fixed at a position over a belt conveyer, the image capturing device captures an image of the target object situated on the belt conveyer. Therefore, the target object is included in the image. However, in cases where the image capturing device is not fixed, there is a possibility that the target object is not included in the image. The cases where the image capturing device is not fixed are, for example, cases where the image capturing device is attached to a worker. When the target object is not included in the image as above, an appropriate test cannot be executed even by using the learned model.

An object of the present disclosure is to execute an appropriate test.

### Means for Solving the Problem

An image processing device according to an aspect of the present disclosure is provided. The image processing device includes an acquisition unit that acquires an image and a testing learned model for testing a target object of a test, an analysis generation unit that analyzes whether the target object is included in the image or not by using the image and generates an analysis result indicating that the image is appropriate as an image used for the test when the target object is included in the image, and a testing unit that tests the target object included in the image by using the image and the testing learned model when the analysis result indicates that the image is appropriate as an image used for the test.

### Effect of the Invention

According to the present disclosure, an appropriate test can be executed.

### BRIEF DESCRIPTION OF THE DRAWINGS

FIG. 1 is a diagram showing hardware included in an image processing device in a first embodiment.

FIG. 2 is a block diagram showing functions of the image processing device in the first embodiment.

FIG. 3 is a block diagram showing functions of an analysis generation unit in the first embodiment.

FIG. 4 is a flowchart showing an example of a process executed by the analysis generation unit in the first embodiment.

FIG. 5 is a block diagram showing functions of a search unit in the first embodiment.

FIG. 6 is a flowchart showing an example of a process executed by the search unit in the first embodiment.

FIG. 7 is a block diagram showing functions of a judgment unit in the first embodiment.

FIG. 8 is a flowchart showing an example of a process executed by the judgment unit in the first embodiment.

FIG. 9 is a block diagram showing functions of an image processing device in a second embodiment.

FIG. 10 is a block diagram showing functions of an image capturing control unit in the second embodiment.

FIG. 11 is a block diagram showing functions of an image processing device in a third embodiment.

FIG. 12 is a block diagram showing functions of an image processing device in a fourth embodiment.

FIG. 13 is a block diagram showing functions of an analysis generation unit in the fourth embodiment.

FIG. 14 is a flowchart showing an example of a process executed by the search unit in the fourth embodiment.

FIG. 15 is a block diagram showing functions of an image processing device in a fifth embodiment.

FIG. 16 is a block diagram showing functions of an image processing device in a sixth embodiment.

FIG. 17 is a block diagram showing functions of an analysis generation unit in the sixth embodiment.

FIG. 18 is a block diagram showing functions of an output control unit in the sixth embodiment.

### MODE FOR CARRYING OUT THE INVENTION

Embodiments will be described below with reference to the drawings. The following embodiments are just examples and a variety of modifications are possible within the scope of the present disclosure.

### First Embodiment

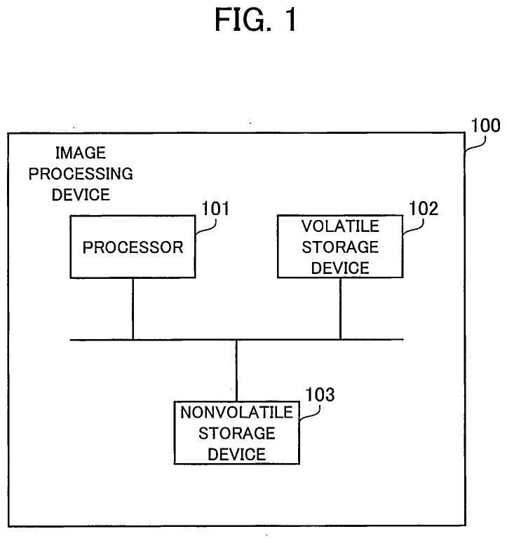

FIG. 1 is a diagram showing hardware included in an image processing device in a first embodiment. The image processing device is a device that executes an image processing method. The image processing device 100 includes a processor 101, a volatile storage device 102 and a nonvolatile storage device 103.

The processor 101 controls the whole of the image processing device 100. The processor 101 is a Central Processing Unit (CPU), a Field Programmable Gate Array (FPGA) or the like, for example. The processor 101 can also be a multiprocessor. Further, the image processing device 100 may include a processing circuitry. The processing circuitry may be either a single circuit or a combined circuit.

The volatile storage device 102 is main storage of the image processing device 100. The volatile storage device 102 is a Random Access Memory (RAM), for example. The nonvolatile storage device 103 is auxiliary storage of the image processing device 100. The nonvolatile storage device 103 is a Hard Disk Drive (HDD) or a Solid State Drive (SSD), for example.

Next, functions included in the image processing device 100 will be described below.

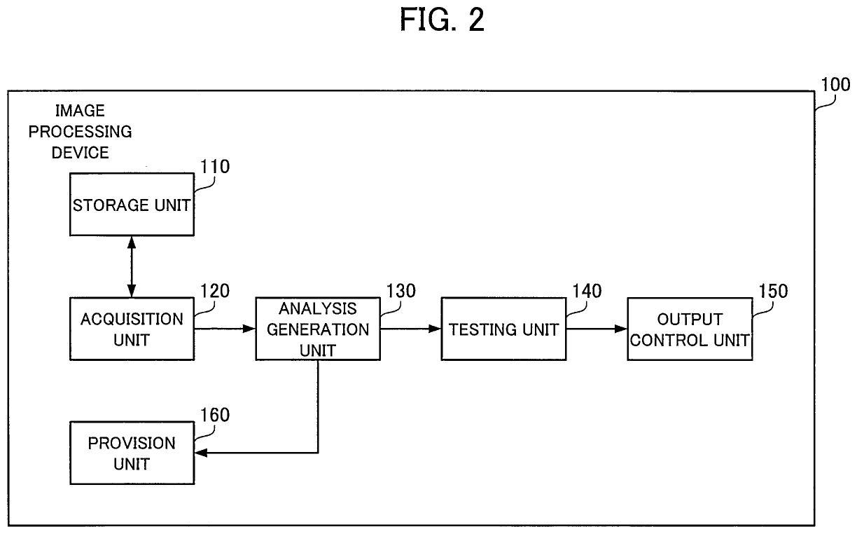

FIG. 2 is a block diagram showing the functions of the image processing device in the first embodiment. The image processing device 100 includes a storage unit 110, an acquisition unit 120, an analysis generation unit 130, a testing unit 140, an output control unit 150 and a provision unit 160.

The storage unit 110 may be implemented as a storage area reserved in the volatile storage device 102 or the nonvolatile storage device 103.

Part or all of the acquisition unit 120, the analysis generation unit 130, the testing unit 140, the output control unit 150 and the provision unit 160 may be implemented by a processing circuitry. Further, part or all of the acquisition unit 120, the analysis generation unit 130, the testing unit 140, the output control unit 150 and the provision unit 160 may be implemented as modules of a program executed by the processor 101. For example, the program executed by the processor 101 is referred to also as an image processing program. The image processing program has been recorded in a record medium, for example.

The acquisition unit 120 acquires an image. For example, the acquisition unit 120 acquires the image from the storage unit 110. Alternatively, for example, the acquisition unit 120 acquires the image from an image capturing device. Incidentally, illustration of the image capturing device is left out.

The acquisition unit 120 acquires a testing learned model. For example, the acquisition unit 120 acquires the testing learned model from the storage unit 110. Here, the testing learned model may also be stored in an external device (e.g., cloud server). In such cases where the testing learned model has been stored in an external device, the acquisition unit 120 acquires the testing learned model from the external device. Incidentally, the testing learned model is a learned model for testing a target object of a test. In other words, the testing learned model is a learned model for estimating a test result of the target object included in the image.

The analysis generation unit 130 analyzes whether the target object of the test is included in the image or not by using the image. Specifically, the analysis generation unit 130 analyzes whether the target object of the test is included in the image or not by using the image and a predetermined method. For example, the predetermined method is pattern matching, generic object recognition technology, specific object recognition technology, or the like. When the target object is included in the image, the analysis generation unit 130 may generate an analysis result indicating that the image is appropriate as an image used for the test. When the target object is not included in the image, the analysis generation unit 130 may generate an analysis result indicating that the image is inappropriate as an image used for the test.

Detailed functions of the analysis generation unit 130 will be described later.

Further, when the image is inappropriate as a target of the test and when the image is appropriate as an image used for the test, the analysis generation unit 130 outputs the analysis result and the image to the provision unit 160.

When the analysis result indicates that the image is appropriate as an image used for the test, the testing unit 140 tests the target object included in the image by using the image and the testing learned model. Specifically, the testing unit 140 inputs information obtained from the image to the testing learned model and thereby obtains a test result outputted from the testing learned model. Incidentally, in the test, it is tested whether the target object has a scratch or not, whether there is a lack of a component or not, and whether there is work omission or not, for example. The work omission is forgetting to tighten a screw or insufficient tightening of a screw, for example.

Further, the testing unit 140 may test the target object included in the image by using the contents of the analysis executed by the analysis generation unit 130, the image and the testing learned model. Furthermore, the testing unit 140 may test the target object by using an image including the target object which cuts out from the image acquired by the acquisition unit 120 (i.e., an image from which the background has been deleted) and the testing learned model. By this method, the testing unit 140 is capable of executing a test with higher accuracy. Incidentally, when executing this test, in a learning phase, learning for executing the test by using a cut-out image including the target object is carried out. By carrying out the learning, the testing learned model to be used for the test is generated.

The output control unit 150 outputs the test result. For example, the output control unit 150 outputs the test result to a display. Alternatively, for example, the output control unit 150 outputs the test result to an external device. It is also possible for the output control unit 150 to output the test result to the storage unit 110.

The provision unit 160 provides information, as information for having an appropriate image be generated, based on the analysis result. Incidentally, the analysis result is the result of performing the analysis on the image. The analysis result may also be represented as a result including a result of analysis of an analysis target which will be described later. For example, when the target object is not included in the image, the provision unit 160 provides a user with information indicating that the target object is not included in the image. Then, the provision unit 160 provides the user with information prompting the user to capture an image so that the target object is included in the image. Further, for example, when the target object has been captured from the side in the image even though the target object should have been captured from the front, the provision unit 160 provides the user with information indicating that composition is inappropriate. Then, the provision unit 160 provides the user with information prompting the user to reconsider the composition. Furthermore, when luminance and sharpness of the image are inappropriate, the provision unit 160 provides the user with information indicating that the luminance and the sharpness are inappropriate. Incidentally, the information provided to the user is displayed on the display, for example. Accordingly, the user recognizes the provided information. In addition, the information provided to the user may also be provided as audio.

The provision of the information by the provision unit 160 enables the user to capture an appropriate image by using the image capturing device.

Next, detailed functions of the analysis generation unit 130 will be described below.

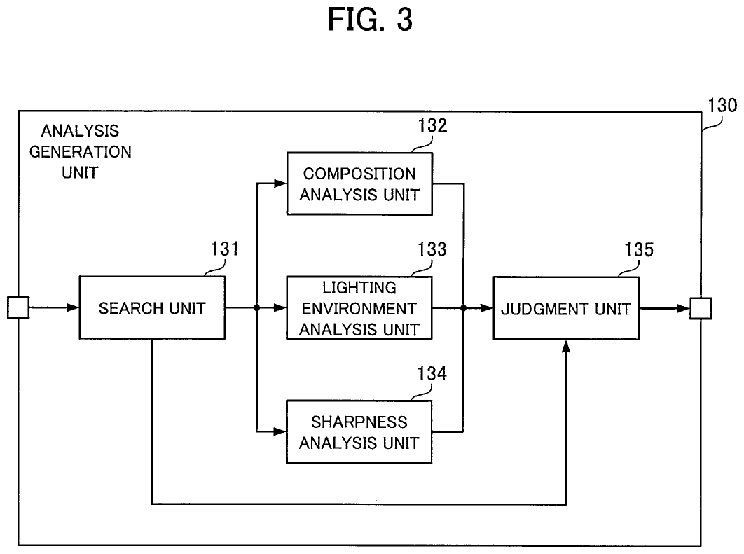

FIG. 3 is a block diagram showing the functions of the analysis generation unit in the first embodiment. The analysis generation unit 130 includes a search unit 131, a composition analysis unit 132, a lighting environment analysis unit 133, a sharpness analysis unit 134 and a judgment unit 135.

The functions of the search unit 131, the composition analysis unit 132, the lighting environment analysis unit 133, the sharpness analysis unit 134 and the judgment unit 135 will be described later.

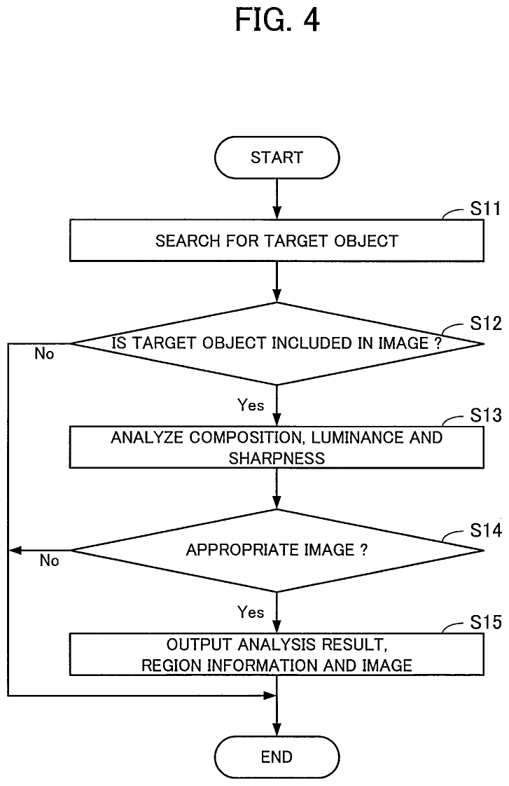

FIG. 4 is a flowchart showing an example of a process executed by the analysis generation unit in the first embodiment.

(Step S11) By using the image acquired by the acquisition unit 120 and a predetermined method, the search unit 131 searches for the target object in the image. Specifically, the search unit 131 searches for a target object region, as a region corresponding to the target object, in the image. For example, the predetermined method is pattern matching, generic object recognition technology, specific object recognition technology, or the like.

(Step S12) The search unit 131 judges whether or not the target object is included in the image. If the target object is included in the image, the process advances to step S13. If the target object is not included in the image, the search unit 131 outputs an analysis result indicating that the image is inappropriate as a target of the test. Then, the process ends.

(Step S13) The composition analysis unit 132 analyzes the composition in regard to the target object based on the target object region in the image. For example, the composition analysis unit 132 analyzes a positional relationship between the image capturing device that generated the image and the target object as the composition. Specifically, the composition analysis unit 132 analyzes whether the image capturing device captured the image of the target object from the front or from the side. Incidentally, the positional relationship may be regarded as a three-dimensional positional relationship. While the positional relationship is generally represented by relative coordinates, the positional relationship may also be represented by absolute coordinates (referred to also as world coordinates, for example). Further, for example, the composition analysis unit 132 analyzes the zooming level when the image of the target object was captured as the composition. Specifically, the composition analysis unit 132 analyzes in what size the target object was captured in the image.

The lighting environment analysis unit 133 analyzes the luminance of the target object region based on the region in the image. In other words, the lighting environment analysis unit 133 analyzes luminance distribution in the region. Further, in other words, the lighting environment analysis unit 133 analyzes at how high brightness the target object was captured in the image. Furthermore, the lighting environment analysis unit 133 may analyze average luminance of the region. Moreover, the lighting environment analysis unit 133 may analyze how the target object was illuminated by an illuminator based on the target object region in the image.

The sharpness analysis unit 134 analyzes the sharpness of the target object region based on the region in the image. The sharpness deteriorates due to defocusing of the image capturing device or the shake (camera shake) of the image capturing device at the time of capturing the image. The sharpness analysis unit 134 may analyze the sharpness in regard to each of the factors such as the defocusing and the shake of the image capturing device. Incidentally, when analyzing the sharpness, the sharpness analysis unit 134 may convert the region into a frequency and analyze the sharpness by using a value and distribution based on the frequency.

(Step S14) The judgment unit 135 judges whether the image is appropriate as an image used for the test or not based on the composition, the luminance and the sharpness (i.e., analysis results of the analysis target). In other words, the judgment unit 135 judges whether the image is appropriate as an image used for the test or not by comprehensively judging the composition, the luminance and the sharpness.

For example, the judgment unit 135 executes the following process in the judgment process. The judgment unit 135 compares the analyzed composition with a predetermined composition. The judgment unit 135 compares the analyzed luminance with a predetermined threshold value. The judgment unit 135 compares the analyzed sharpness with a predetermined threshold value.

Further, for example, the judgment unit 135 may input at least one of the luminance and the sharpness to a previously prepared numerical expression and judge whether the image is appropriate or not based on a value outputted by the numerical expression.

Conditions used for judging whether the image is appropriate as an image used for the test or not will be explained below by using concrete examples. For example, a screw as the target object is included in the image. A first condition is that the composition is a composition in which the image of the screw was captured from an angle larger than a prescribed angle with respect to the screw's fastening direction so that a contact surface between the screw as a fastening part and an object as a fastening target is visible. A second condition is that the sharpness is sharpness with which a groove occurring between the screw and the object as the fastening target in a state in which the fastening is inferior can be clearly detected. A third condition is that the luminance is luminance with which the groove, the screw and the object as the fastening target can be discriminated. Incidentally, the angle, the sharpness and the luminance may be determined based on know-how of a skilled worker or set at values for making the testing learned model execute an appropriate test. The values for making the testing learned model execute an appropriate test can be, for example, values obtained as the angle of the target object, the sharpness and the luminance included in the learning data used for generating the testing learned model.

Further, weights may be assigned to the image capturing angle derived from the composition, the analyzed sharpness, and the analyzed luminance. The judgment unit 135 may judge whether the image is appropriate as an image used for the test or not based on the sum total of the weighted image capturing angle, the weighted sharpness and the weighted luminance and a predetermined value.

If the image is appropriate as an image used for the test, the process advances to step S15. If the image is inappropriate as an image used for the test, the judgment unit 135 outputs an analysis result indicating that the image is inappropriate as an image used for the test. Then, the process ends.

(Step S15) The judgment unit 135 outputs an analysis result indicating that the image is appropriate as an image used for the test, region information indicating the target object region in the image, and the image to the testing unit 140. The region information may also be included in the analysis result.

Incidentally, it can be said that the analysis result is generated by the analysis generation unit 130.

As above, even when the target object is included in the image, the image processing device 100 judges whether or not the image is appropriate as an image used for the test. Accordingly, the image processing device 100 is capable of preventing a test using an inappropriate image.

Here, the search unit 131 may have the following functions.

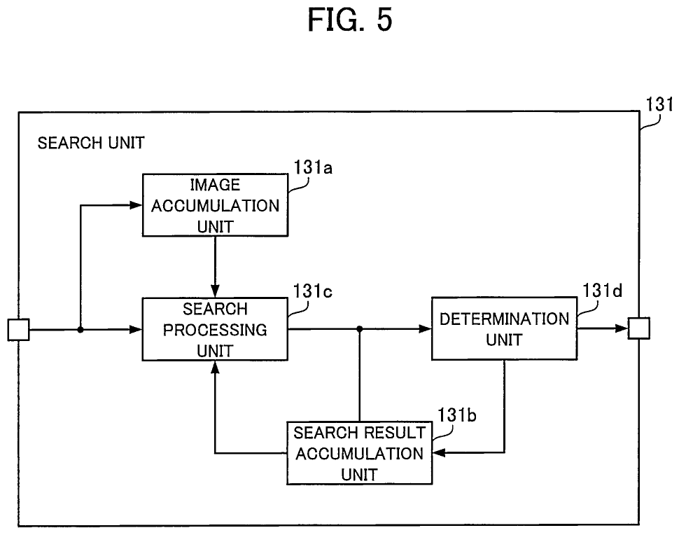

FIG. 5 is a block diagram showing the functions of the search unit in the first embodiment. The search unit 131 includes an image accumulation unit 131a, a search result accumulation unit 131b, a search processing unit 131c and a determination unit 131d. Incidentally, the image accumulation unit 131a and the search result accumulation unit 131b may be implemented by the storage unit 110.

First, the acquisition unit 120 acquires a plurality of images obtained by successively photographing the target object. For example, the plurality of images are 30 images obtained by successively photographing the target object for one second. In short, the plurality of images are images obtained by continuous shooting by the image capturing device. Alternatively, the plurality of images can also be a plurality of frames constituting a video.

The image accumulation unit 131a accumulates past images as images that have undergone the search for the target object among the plurality of images. Since the past images are images obtained by the continuous shooting, the time when the past images was generated does not differ much from the time when a present image which will be explained later was generated. The past images include the same target object as that in the present image. Further, the positions of the target object included in the past images and the present image do not differ much from each other. A predetermined number of images are accumulated in the image accumulation unit 131a. Each time the number is exceeded, the images are deleted one by one in chronological order. When a plurality of images similar to each other have been stored in the image accumulation unit 131a, the plurality of images may be deleted preferentially. This is for making the image accumulation unit 131a store as many different images as possible. This is also for making it possible to make a comparison by using different images as will be described later. Incidentally, the similarity is judged based on, for example, whether or not the average of absolute differences of pixel values is less than or equal to a constant. Further, the images stored in the image accumulation unit 131a may be deleted when a predetermined period has elapsed.

The search result accumulation unit 131b accumulates search results regarding the past images. Further, the search results stored in the search result accumulation unit 131b are deleted in chronological order.

The search processing unit 131c searches for the target object in the present image as an image that has not undergone the search among the plurality of images. The method of the search is the same as that in the step S11.

Further, the search processing unit 131c may search for the target object in the present image based on past images and the search results regarding the past images. For example, the present image is assumed to have been generated at time t. The search result regarding a past image generated at time t−1 is assumed to be f(t−1). The search result regarding a past image generated at time t−2 is assumed to be f(t−2). The search result f(t) regarding the present image is estimated as “f(t−1)+{f(t−1)−f(t−2)}”. Incidentally, “f(t−1)+{f(t−1)−f(t−2)}” holds when the difference between “t−1” and “t−2” is minute and when movement of the image capturing device and movement of the target object do not change rapidly. By this method, the search processing unit 131c is capable of searching for the target object in the present image. Furthermore, the search processing unit 131c may determine a search result obtained by assigning weights to the search results regarding past images as the search result regarding the present image.

The determination unit 131d compares the position of the target object in the present image with the position of the target object in the past images based on the past images, the search results regarding the past images, and the search result regarding the present image, and outputs the search result regarding the present image when the error is less than a predetermined threshold value. When the error is greater than or equal to the threshold value, the determination unit 131d determines the average of the position of the target object in the present image and the position of the target object in the past images as the search result regarding the present image. The determination unit 131d may assign a weight to the average. When the error is greater than or equal to the threshold value, the determination unit 131d may group the target object region in the present image and the target object region in the past images, determine a region from the grouped plurality of regions by decision by majority, and determine the determined region as the search result regarding the present image.

The determination unit 131d stores the search result in the search result accumulation unit 131b.

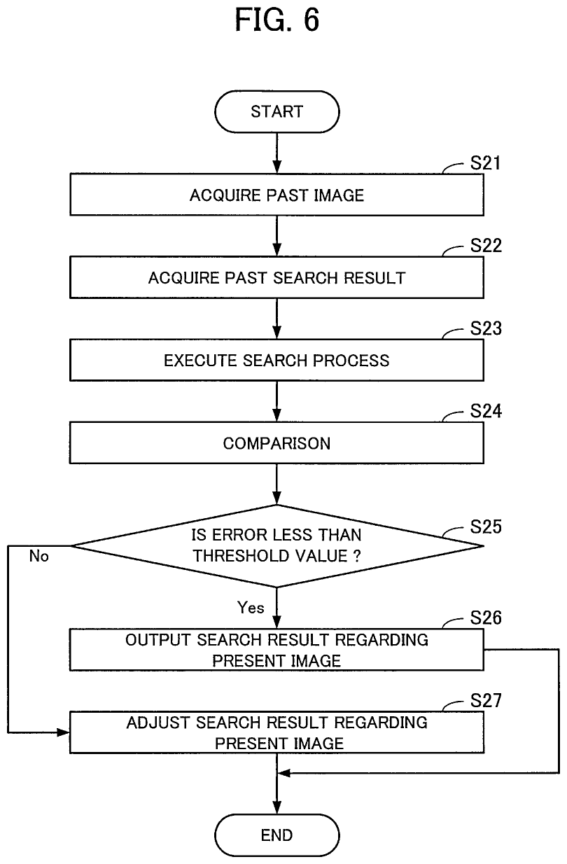

FIG. 6 is a flowchart showing an example of a process executed by the search unit in the first embodiment.

(Step S21) The search processing unit 131c acquires the past images from the image accumulation unit 131a.

(Step S22) The search processing unit 131c acquires the search result regarding each past images from the search result accumulation unit 131b.

(Step S23) The search processing unit 131c searches for the target object in the present image.

(Step S24) The determination unit 131d compares the position of the target object in the present image with the position of the target object in the past images based on the past images, the search results regarding the past images, and the search result regarding the present image.

(Step S25) The determination unit 131d judges whether or not the error is less than the threshold value. If the error is less than the threshold value, the process advances to step S26. If the error is greater than or equal to the threshold value, the process advances to step S27.

(Step S26) The determination unit 131d outputs the search result regarding the present image.

(Step S27) The determination unit 131d determines the average of the position of the target object in the present image and the position (s) of the target object in one or more past images as the search result regarding the present image. Incidentally, the method using the average is just an example. As above, when the search result regarding the present image is undesirable, the image processing device 100 adjusts the search result regarding the present image. Accordingly, the image processing device 100 makes the analysis of the sharpness and the like in regard to the region indicated by the adjusted search result. Thus, the image processing device 100 is capable of making an appropriate analysis.

Incidentally, after the step S26 or the step S27, the composition, the luminance and the sharpness are analyzed based on the region indicated by the search result regarding the present image. For example, after the step S26, the composition, the luminance and the sharpness are analyzed based on the target object region in the present image.

Here, in the case where the acquisition unit 120 acquires a plurality of images obtained by successively photographing the target object, the judgment unit 135 may have the following functions.

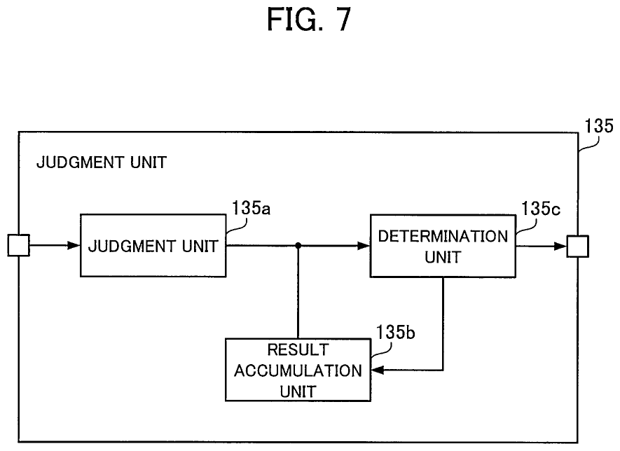

FIG. 7 is a block diagram showing the functions of the judgment unit in the first embodiment. The judgment unit 135 includes a judgment unit 135a, a result accumulation unit 135b and a determination unit 135c. Incidentally, the result accumulation unit 135b may be implemented by the storage unit 110.

The judgment unit 135a judges whether the present image is appropriate as an image used for the test or not based on the composition, the luminance and the sharpness obtained by analyzing the present image (i.e., results of the analysis target). Specifically, the judgment unit 135a executes the same processing as in the step S14.

The result accumulation unit 135b accumulates past judgment results indicating whether or not each past image is appropriate as an image used for the test. When a predetermined number or a predetermined period is exceeded, the past judgment results are deleted one by one in chronological order.

The determination unit 135c compares the past judgment result with a present judgment result indicating whether the present image is appropriate as an image used for the test or not, and outputs the present judgment result when the judgment results coincide with each other. When the judgment results do not coincide with each other, the determination unit 135c makes a decision by majority based on the past judgment result and the present judgment result, and determines a judgment result based on the decision by majority as the present judgment result. Here, the present image is one image among the plurality of images obtained by successively photographing. Since the photographing was performed at short intervals, the judgment result is considered not to change. Therefore, the image processing device 100 adjusts the present judgment result to the past judgment result. By this, even when the accuracy of the judgment unit 135a is undesirable, the image processing device 100 can adjust the judgment result.

The determination unit 135c stores the present judgment result in the result accumulation unit 135b.

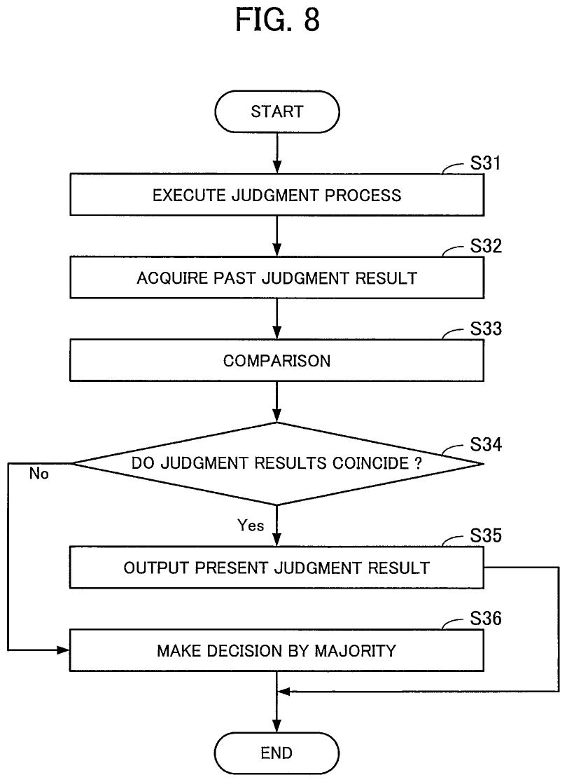

FIG. 8 is a flowchart showing an example of a process executed by the judgment unit in the first embodiment.

(Step S31) The judgment unit 135a judges whether the present image is appropriate as an image used for the test or not based on the composition, the luminance and the sharpness obtained by analyzing the present image.

(Step S32) The determination unit 135c acquires the past judgment result from the result accumulation unit 135b.

(Step S33) The determination unit 135c compares the past judgment result with the present judgment result.

(Step S34) The determination unit 135c judges whether or not the judgment results coincide with each other. If the judgment results coincide with each other, the process advances to step S35. If the judgment results do not coincide with each other, the process advances to step S36.

(Step S35) The determination unit 135c outputs the present judgment result.

(Step S36) The determination unit 135c makes the decision by majority based on the past judgment result and the present judgment result, and determines the judgment result based on the decision by majority as the present judgment result.

According to the first embodiment, the image processing device 100 does not execute the test when the target object is not included in the image. The image processing device 100 executes the test when the target object is included in the image. Therefore, the image processing device 100 is capable of executing an appropriate test.

Further, according to the first embodiment, even when the target object is included in the image, the image processing device 100 judges whether the image is appropriate as an image used for the test or not based on the composition, the luminance and the sharpness. Accordingly, the image processing device 100 is capable of preventing a test using an inappropriate image.

### Modification of First Embodiment

In a modification of the first embodiment, a description will be given of a case where the functions of the analysis generation unit 130 are implemented by a learned model. Here, the learned model is referred to as an analyzing learned model. The analyzing learned model is a learned model for inferring whether the image is appropriate as an image used for the test or not.

First, the learning phase for generating the analyzing learned model and the testing learned model will be described below. In the learning phase, an image, an analysis result having the same contents as those outputted from the analysis generation unit 130, and a test result having the same contents as those outputted from the testing unit 140 are prepared as learning data. Further, in the learning of the testing learned model, when an analysis result outputted from the analyzing learned model indicates that the image is an appropriate image, the appropriate image may be used as learning data.

The learning data may also be selected by the user. For example, the user selects an image for which an analysis result indicating that the image is an appropriate image is expected to be outputted. For example, in the test, screw fastening is tested based on a gap in a spring washer part. Therefore, the user selects an image in which the luminance and the sharpness of the spring washer part are appropriate.

In the learning phase, when the testing learned model outputs an erroneous test result, the analyzing learned model is relearned so that the analyzing learned model outputs an analysis result indicating that the image is not an appropriate image. Further, the analyzing learned model and the testing learned model may also be generated individually. The analyzing learned model for inferring an image analysis result from an image is generated by machine learning by using combinations of an image and an image analysis result as the learning data. The testing learned model for inferring a test result of the target object from an image is generated by machine learning by using combinations of an image and a test result as the learning data.

The machine learning is executed by a non-illustrated learning device. The learning device may be either installed in the image processing device or housed in an external device. Publicly known algorithm such as supervised learning, unsupervised learning or reinforcement learning can be used as the learning algorithm used by the learning device. In the supervised learning, a neural network model can be used, for example.

The analyzing learned model is acquired by the acquisition unit 120. For example, the acquisition unit 120 acquires the analyzing learned model from the storage unit 110. Here, the analyzing learned model may also be stored in an external device. In such cases where the analyzing learned model has been stored in the external device, the acquisition unit 120 acquires the analyzing learned model from the external device.

The analysis generation unit 130 analyzes whether the image is appropriate as an image used for the test or not by using the image and the analyzing learned model. Specifically, the analysis generation unit 130 inputs information based on the image to the analyzing learned model, and accordingly, the analyzing learned model outputs an analysis result indicating whether the image is appropriate as an image used for the test or not. As described above, the analyzing learned model has the same function as the analysis generation unit 130.

Accordingly, the modification of the first embodiment achieves the same effects as the first embodiment even when the analyzing learned model is used.

### Second Embodiment

Next, a second embodiment will be described below. In the second embodiment, the description will be given mainly of features different from those in the first embodiment. In the second embodiment, the description is omitted for features in common with the first embodiment.

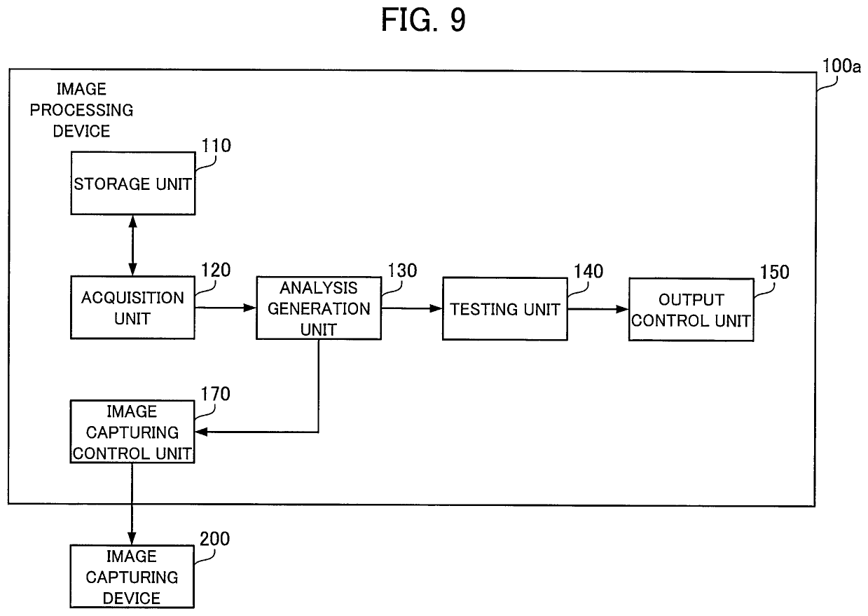

FIG. 9 is a block diagram showing functions of an image processing device in the second embodiment. Each component in FIG. 9 being the same as a component shown in FIG. 2 is assigned the same reference character as in FIG. 2.

An image processing device 100a is connected to an image capturing device 200. The image processing device 100a includes an image capturing control unit 170. Part or the whole of the image capturing control unit 170 may be implemented by a processing circuitry. Further, part or the whole of the image capturing control unit 170 may be implemented as modules of a program executed by the processor 101.

First, when the image is inappropriate as an image used for the test and when the image is appropriate as an image used for the test, the analysis generation unit 130 outputs the analysis result to the image capturing control unit 170.

Based on the analysis result, the image capturing control unit 170 controls the image capturing device 200 so that the image capturing device 200 generates an appropriate image. Detailed functions of the image capturing control unit 170 will be described below.

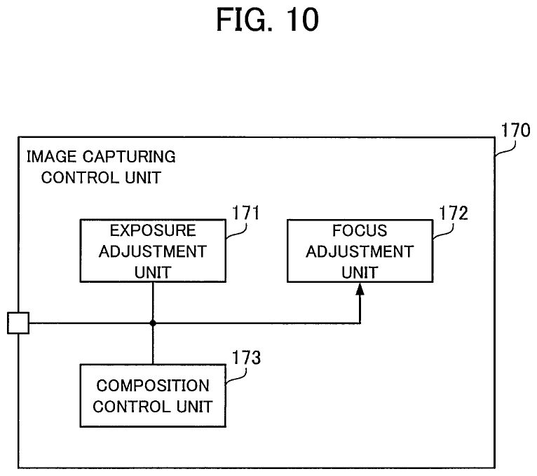

FIG. 10 is a block diagram showing the functions of the image capturing control unit in the second embodiment. The image capturing control unit 170 includes an exposure adjustment unit 171, a focus adjustment unit 172 and a composition control unit 173.

The exposure adjustment unit 171 adjusts parameters regarding exposure based on the luminance indicated by the analysis result. For example, the parameters are the aperture, the shutter speed, the photographing sensitivity, and so forth. The exposure adjustment unit 171 adjusts the parameters so as to achieve predetermined luminance. The exposure adjustment unit 171 may also adjust the parameters based on information regarding properties of the image capturing device 200.

The focus adjustment unit 172 adjusts the focus of the image capturing device 200 based on the sharpness indicated by the analysis result and the target object region in the image. Specifically, the focus adjustment unit 172 adjusts the focus of the image capturing device 200 so that the sharpness of the region increases.

The composition control unit 173 controls the image capturing device 200 based on the composition indicated by the analysis result. For example, the composition control unit 173 controls a zoom function of the image capturing device 200 based on the composition. Further, for example, when changing the composition, the composition control unit 173 controls a movable part connected to the image capturing device 200 based on the composition.

The image capturing control unit 170 may provide the user with the parameters, information regarding the focus, information regarding the zoom (zooming in/out), and information for changing the movable part.

Further, the image capturing control unit 170 may control the image capturing device 200 so that the image capturing device 200 generates a plurality of images with different exposures, different focuses and different compositions. This enables the acquisition unit 120 to acquire a plurality of images obtained by photographing in different conditions. Then, for each of the plurality of images, the analysis generation unit 130 analyzes whether or not the image is appropriate as an image used for the test. As above, the image processing device 100a is capable of decreasing inappropriate images as an image used for the test by making the image capturing device 200 generate a plurality of images as images of different variations.

Furthermore, the plurality of images obtained by photographing in different conditions can be a plurality of images obtained by successively photographing the target object. In short, the plurality of images can be a plurality of images obtained by successively photographing the target object in different conditions. Based on the search result regarding the past image among the plurality of images and the search result regarding the present image among the plurality of images, when the error between the position of the target object in the present image and the position of the target object in the past image is greater than or equal to a predetermined threshold value, the determination unit 131d may determine the average of the position of the target object in the present image and the position (s) of the target object in one or more past images as the search result regarding the present image. Moreover, the determination unit 135c may compare the past judgment result and the present judgment result, and when the judgment results do not coincide with each other, may make a decision by majority based on the past judgment result and the present judgment result and determines a judgment result based on the decision by majority as the present judgment result.

### Third Embodiment

Next, a third embodiment will be described below. In the third embodiment, the description will be given mainly of features different from those in the first or second embodiment. In the third embodiment, the description is omitted for features in common with the first or second embodiment.

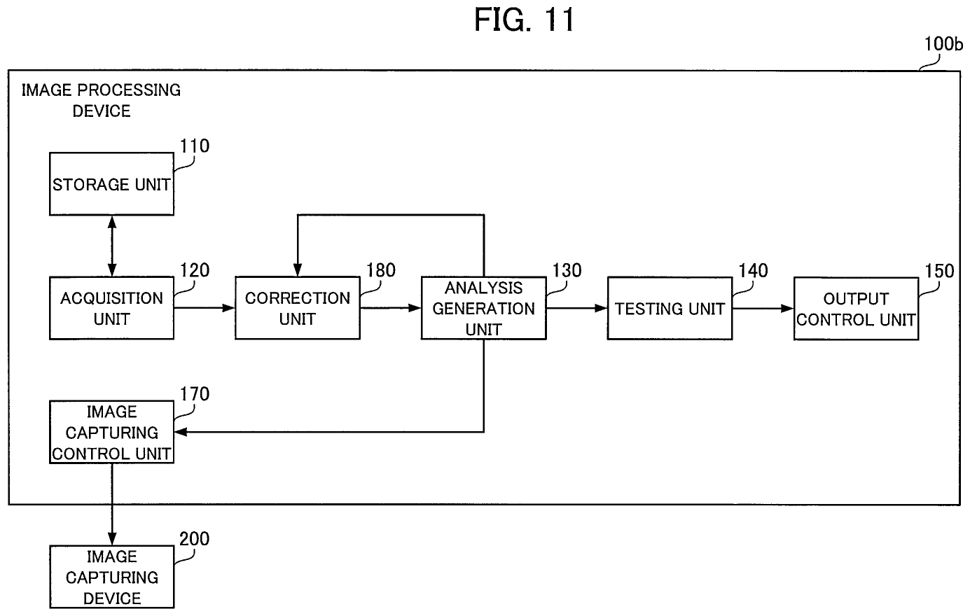

FIG. 11 is a block diagram showing functions of an image processing device in the third embodiment. Each component in FIG. 11 being the same as a component shown in FIG. 2 is assigned the same reference character as in FIG. 2.

An image processing device 100b includes a correction unit 180. Part or the whole of the correction unit 180 may be implemented by a processing circuitry. Further, part or the whole of the correction unit 180 may be implemented as modules of a program executed by the processor 101.

First, the acquisition unit 120 acquires a plurality of images obtained by successively photographing the target object.

The analysis generation unit 130 generates an analysis result regarding a first image among the plurality of images.

The correction unit 180 corrects a second image, as one image among the plurality of images and an image generated immediately after the first image, based on the analysis result. For example, when the analysis result indicates that the analyzed luminance is lower than the threshold value, the correction unit 180 makes a correction for setting the luminance of the second image to be higher than or equal to the threshold value. For example, when the analysis result indicates that the analyzed sharpness is lower than the threshold value, the correction unit 180 makes a correction for setting the sharpness of the second image to be higher than or equal to the threshold value. The image processing device 100b corrects the second image as above, thus the second image turns into an image appropriate for the test.

Further, when the analysis result indicates that the first image is inappropriate as an image used for the test, the correction unit 180 may correct the first image based on the analysis result.

The plurality of images can be a plurality of images obtained by successively photographing the target object in different conditions. In short, the plurality of images can be images of different variations generated by the image capturing device 200. The correction unit 180 may correct all or part of the plurality of images. For example, the correction unit 180 corrects the plurality of images based on the average of noise amounts of the plurality of images. By this, overall noise in the plurality of images is reduced. Alternatively, for example, the correction unit 180 assigns weights to luminance averages of the plurality of images and corrects the plurality of images based on a value obtained by assigning the weights. As above, the image processing device 100b is capable of making the correction in a range that is impossible in one image.

### Fourth Embodiment

Next, a fourth embodiment will be described below. In the fourth embodiment, the description will be given mainly of features different from those in the first embodiment. In the fourth embodiment, the description is omitted for features in common with the first embodiment.

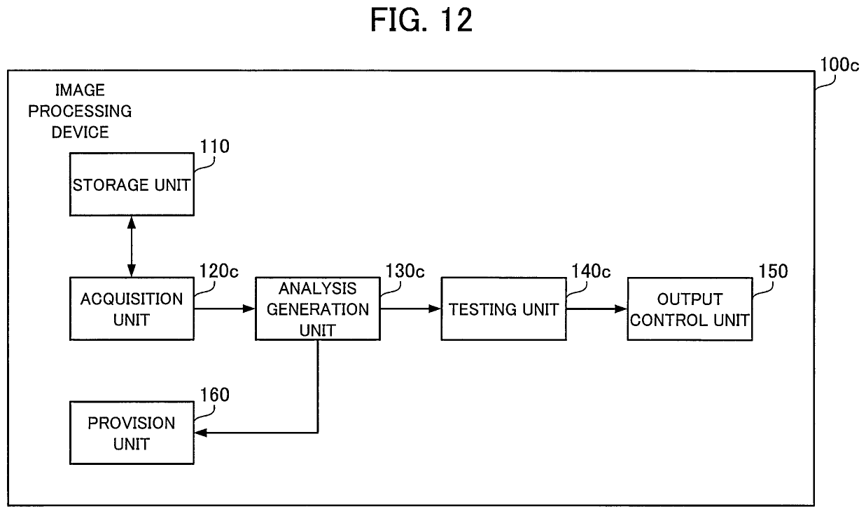

FIG. 12 is a block diagram showing functions of an image processing device in the fourth embodiment. Each component in FIG. 12 being the same as a component shown in FIG. 2 is assigned the same reference character as in FIG. 2. An image processing device 100c includes an acquisition unit 120c, an analysis generation unit 130c and a testing unit 140c.

The acquisition unit 120c acquires sensor information. For example, the acquisition unit 120c acquires the sensor information from a sensor. The sensor is attached to an image capturing device or the outside of the image capturing device. For example, the sensor senses conditions of the image capturing device and a worker. The sensor information is information obtained by detection by the sensor. In other words, the sensor information is information obtained by measurement by the sensor. Specifically, the sensor information is information indicating movement of the worker and the image capturing device (referred to also as gyro information, for example), information indicating a sight line direction of the worker, information indicating illuminance of a region photographed by the image capturing device, information indicating the distance from the image capturing device to the region photographed by the image capturing device, or the like. Incidentally, in the case where the sensor is attached to something outside the image capturing device, the image processing device 100c is capable of detecting the three-dimensional positional relationship including postures of the sensor and the image capturing device. For example, the image processing device 100c is capable of detecting the three-dimensional positional relationship based on the sensor information obtained by cooperation of a sensor attached to the image capturing device and a sensor attached to the outside of the image capturing device. Further, for example, the image processing device 100c is capable of detecting the three-dimensional positional relationship by calculating the position of the image capturing device based on the sensor information acquired from a sensor attached to the outside of the image capturing device.

Incidentally, the acquisition unit 120c acquires the image and the testing learned model similarly to the acquisition units in the first to third embodiments.

The analysis generation unit 130c (specifically, the search unit 131) analyzes whether the target object is included in the image or not based on the sensor information and the image. For example, in cases where a sight line detection sensor and the image capturing device are integral with each other, the sensor information includes sight line information regarding the worker. The analysis generation unit 130c detects a region in the image that is viewed by the worker based on the sight line information. The region viewed by the worker can be regarded as a region in which the target object exists. Therefore, the analysis generation unit 130c analyzes that the target object exists in the region. Accordingly, the analysis generation unit 130c analyzes that the target object is included in the image.

When the target object is included in the image, the analysis generation unit 130c analyzes the composition, the luminance and the sharpness based on the sensor information and the image. The analysis generation unit 130c will be described in detail below.

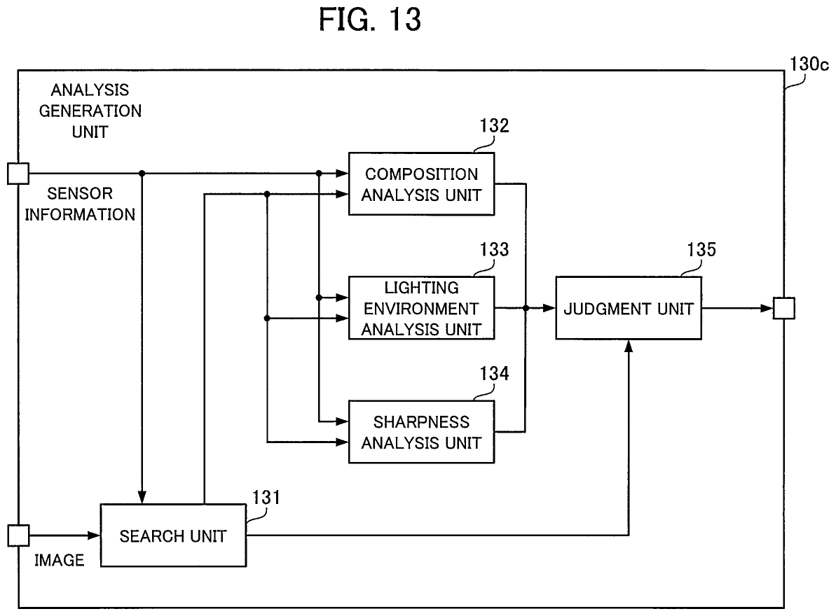

FIG. 13 is a block diagram showing functions of the analysis generation unit in the fourth embodiment. The image and the sensor information are inputted to the analysis generation unit 130c.

The composition analysis unit 132 analyzes the positional relationship between the image capturing device and the target object, as the composition, based on the movement of the image capturing device indicated by the sensor information. Specifically, the composition analysis unit 132 determines the present position of the image capturing device by adding positions of moved the image capturing device for a time length to a reference position indicated by position information on the image capturing device at a certain time point. The composition analysis unit 132 analyzes the positional relationship between the present position of the image capturing device and the position of the target object based on the reference position of the image capturing device and the position of the target object.

When the composition based on the image and the composition based on the sensor information differ from each other, the composition analysis unit 132 may determine a composition obtained by assigning a weight to the composition based on the sensor information as the composition based on the image. Further, the composition analysis unit 132 may search for the target object in the present image by assigning weights to the search results regarding past images.

The lighting environment analysis unit 133 analyzes the luminance of the region in which the target object exists based on the sensor information. Incidentally, the sensor information is the exposure of the image capturing device, for example. In cases where the sensor is an illuminometer, for example, the sensor information is illuminance information. For example, the lighting environment analysis unit 133 assigns weights to the luminance based on the image and the luminance based on the sensor information and analyzes the average of the weighted values as the luminance to be inputted to the judgment unit 135.

The sharpness analysis unit 134 analyzes the sharpness of the region in which the target object exists based on the sensor information. For example, the sharpness analysis unit 134 analyzes an amount indicating the shake based on the movement of the image capturing device indicated by the sensor information. The sharpness analysis unit 134 analyzes the sharpness based on the amount. Further, for example, in the case where the sensor information is information indicating the distance from the image capturing device to the region photographed by the image capturing device, the sharpness analysis unit 134 analyzes the defocusing based on the distance. The sharpness analysis unit 134 analyzes the sharpness based on the defocusing. For example, the sharpness analysis unit 134 assigns weights to the sharpness based on the image and the sharpness based on the sensor information and analyzes the average of the weighted values as the sharpness to be inputted to the judgment unit 135.

Here, the search unit 131 may execute the following process.

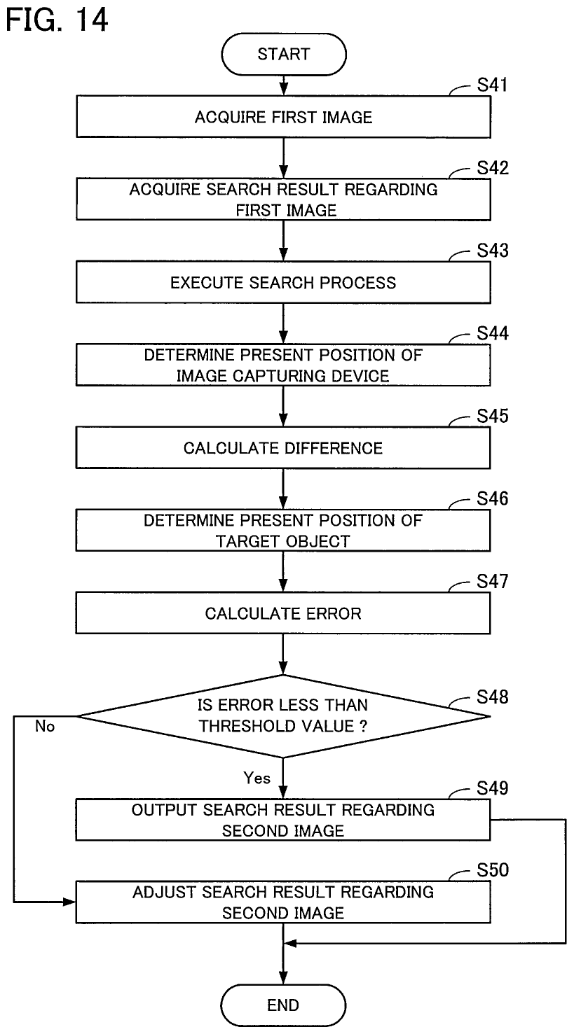

FIG. 14 is a flowchart showing an example of a process executed by the search unit in the fourth embodiment. In the process of FIG. 14, a plurality of images obtained by successively photographing the target object have been acquired by the acquisition unit 120c.

(Step S41) The search processing unit 131c acquires a first image as a past image from the image accumulation unit 131a. Incidentally, the first image is one image among the plurality of images.

(Step S42) The search processing unit 131c acquires the search result regarding the first image from the search result accumulation unit 131b.

(Step S43) The search processing unit 131c searches for the target object in a second image generated immediately after the first image.

(Step S44) The search processing unit 131c determines the present position of the image capturing device based on the movement of the image capturing device indicated by the sensor information.

(Step S45) The search processing unit 131c calculates the difference between the past position of the image capturing device determined based on the sensor information acquired the previous time and the present position of the image capturing device. The difference can be regarded as a movement amount of the target object.

(Step S46) The search processing unit 131c determines the present position of the target object based on the search result regarding the first image and the difference. In short, the search processing unit 131c determines the present position of the target object by adding the difference to the position of the target object included in the first image.

(Step S47) The determination unit 131d calculates an error by comparing the position of the target object in the second image searched in the step S43 with the present position of the target object determined in the step S46.

(Step S48) The determination unit 131d judges whether or not the error is less than the threshold value. If the error is less than the threshold value, the process advances to step S49. If the error is greater than or equal to the threshold value, the process advances to step S50.

(Step S49) The determination unit 131d outputs the search result regarding the second image.

(Step S50) The determination unit 131d determines the average of the position of the target object in the second image and the present position of the target object as the search result regarding the second image. As above, when the search result regarding the second image is undesirable, the image processing device 100c adjusts the search result regarding the second image. Accordingly, the image processing device 100d makes the analysis of the sharpness and the like in regard to the region indicated by the adjusted search result. Thus, the image processing device 100d is capable of making an appropriate analysis.

Further, when the error is greater than or equal to the threshold value, the determination unit 131d may generate an analysis result indicating that the second image is inappropriate as an image used for the test.

Here, in cases where the search unit 131 makes the search by using template matching, whether images match each other or not is judged based on a similarity level. In cases where photographing environment when a template image was generated and photographing environment when the acquired image was generated differ from each other, an influence appears in the similarity level. Therefore, the search unit 131 calculates the similarity level in consideration of exposure information indicated by the sensor information. Accordingly, search accuracy increases.

When the analysis result indicates that the image is appropriate as an image used for the test, the testing unit 140c tests the target object included in the image by using the sensor information, the image and the testing learned model. The testing unit 140c is capable of increasing the test accuracy by using the sensor information. For example, when the target object included in an image with low illuminance is tested without using the sensor information, there is a possibility of low test accuracy. Therefore, when the testing unit 140c tests the target object included in an image with low illuminance by using the illuminance indicated by the sensor information, the testing unit 140c tests the target object in consideration of the sensor information. Accordingly, the testing unit 140c is capable of outputting a test result with high test accuracy.

Further, the provision unit 160 may be replaced with the image capturing control unit 170. For example, in the case where the sensor information is information indicating the distance from the image capturing device to the region photographed by the image capturing device, the image capturing control unit 170 may adjust the focus based on the sensor information. Further, for example, the image capturing control unit 170 may adjust the exposure based on illuminance information indicated by the sensor information. The image capturing control unit 170 may control the image capturing device based on the sensor information and the analysis result.

According to the fourth embodiment, the image processing device 100c is capable of making an analysis with high accuracy by using the sensor information.

### Fifth Embodiment

Next, a fifth embodiment will be described below. In the fifth embodiment, the description will be given mainly of features different from those in the fourth embodiment. In the fifth embodiment, the description is omitted for features in common with the fourth embodiment.

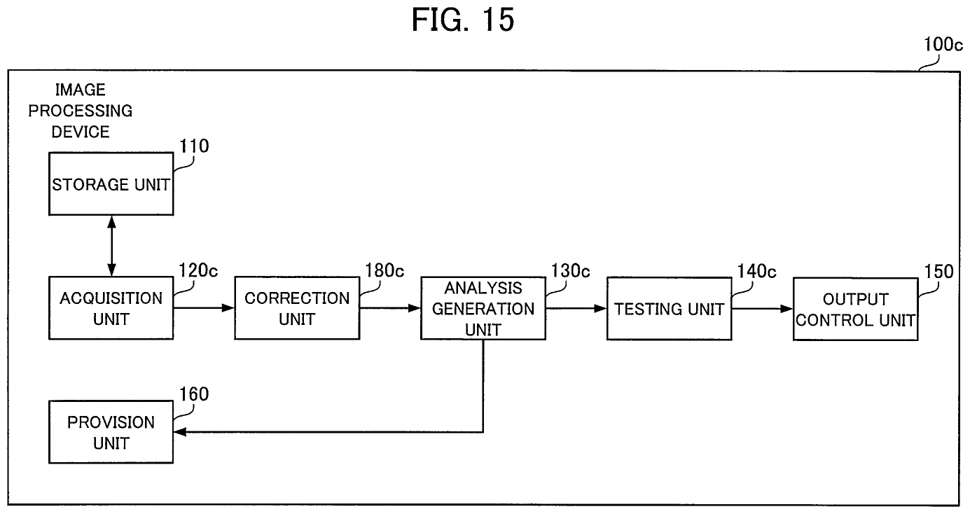

FIG. 15 is a block diagram showing functions of an image processing device in the fifth embodiment. Each component in FIG. 15 being the same as a component shown in FIG. 12 is assigned the same reference character as in FIG. 12.

The image processing device 100c further includes a correction unit 180c. The correction unit 180c corrects the image acquired by the acquisition unit 120c by using the sensor information. For example, the correction unit 180c calculates the direction and magnitude of the shake due to the movement of the image capturing device based on the movement of the image capturing device indicated by the sensor information, and corrects the image based on the results of the calculation. Specifically, the correction unit 180c calculates a point spread function h based on the direction and the magnitude of the shake. Here, an image with no occurrence of the shake is represented as an image f. Fourier transform of the image f is represented as F. Fourier transform of the point spread function h is represented as H. The relationship with Fourier transform G of an image g with the occurrence of the shake is represented as “G=HF” by using a convolution operation. When the inverse filter of the Fourier transform H is Hinv, “F=HinvG” holds. When inverse Fourier transform is performed based on “F=HinvG”, the image f is estimated from the image g.

Further, in the case where the sensor information is information indicating the illuminance of the region photographed by the image capturing device, the correction unit 180c may correct the sharpness of the image by using the sensor information. Furthermore, the correction unit 180c may correct the luminance of the image based on the illuminance indicated by the sensor information.

The correction unit 180c may correct the image based on the analysis result generated by the analysis generation unit 130c and the sensor information.

According to the fifth embodiment, the image processing device 100c is capable of increasing the probability that the image is judged to be appropriate as an image used for the test by correcting the image by using the sensor information.

### Sixth Embodiment

Next, a sixth embodiment will be described below. In the sixth embodiment, the description will be given mainly of features different from those in the first embodiment. In the sixth embodiment, the description is omitted for features in common with the first embodiment.

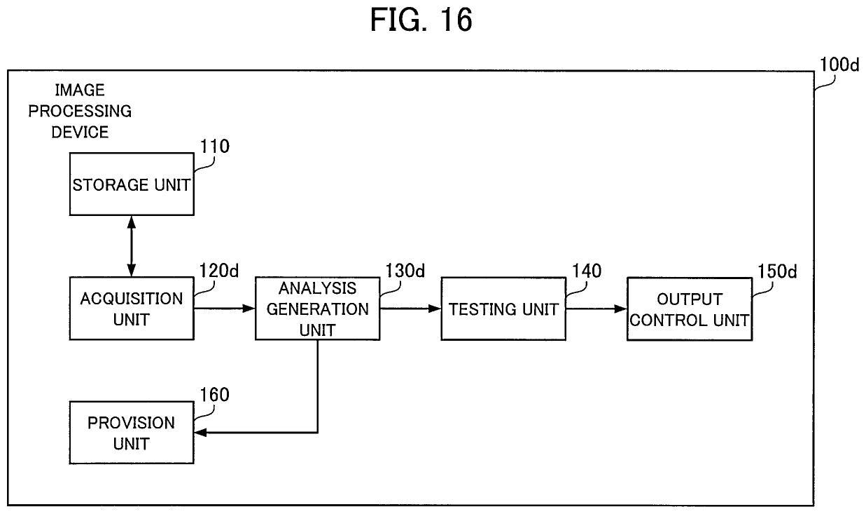

FIG. 16 is a block diagram showing functions of an image processing device in the sixth embodiment. Each component in FIG. 16 being the same as a component shown in FIG. 2 is assigned the same reference character as in FIG. 2. The image processing device 100d includes an acquisition unit 120d, an analysis generation unit 130d and an output control unit 150d.

The acquisition unit 120d acquires the sensor information. Further, the acquisition unit 120d acquires drawing information. For example, the acquisition unit 120d acquires drawing information from a server. The drawing information is 3D-CAD data or the like, for example. The drawing information includes one or more target objects. For example, the drawing information is information regarding the design such as various dimensions and tolerances in regard to a fastening part of a screw as the target object and an object as a fastening target, and indicates the whole or part of a product.

Incidentally, the acquisition unit 120d acquires the image and the testing learned model as in the first embodiment.

Next, the analysis generation unit 130d will be described in detail below.

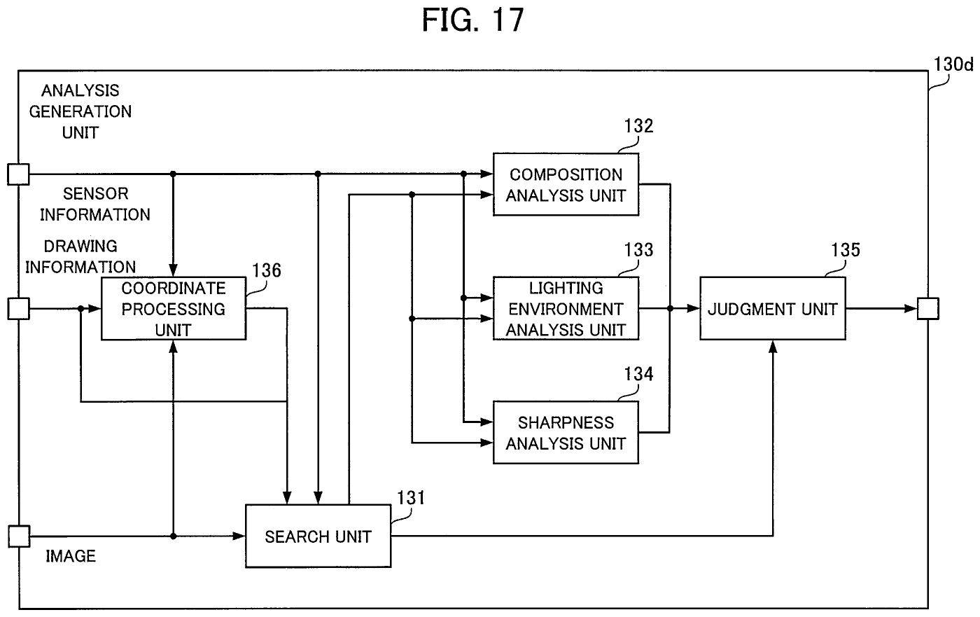

FIG. 17 is a block diagram showing functions of the analysis generation unit in the sixth embodiment. The image, the sensor information and the drawing information are inputted to the analysis generation unit 130d.

The analysis generation unit 130d includes a coordinate processing unit 136. The coordinate processing unit 136 integrates a coordinate system of the drawing information and a coordinate system of the image by using the image, the sensor information and the drawing information. The integrated coordinate system will hereinafter be referred to as a world coordinate system. A predetermined position is set as the origin of the world coordinate system. A feature point of the target object indicated by the drawing information may be set at the origin of the world coordinate system. The coordinate processing unit 136 calculates the coordinates of the feature point in the world coordinate system. In short, the coordinate processing unit 136 calculates the coordinates of the feature point based on the distance between the origin and the feature point. Further, the coordinate processing unit 136 calculates the coordinates of each pixel of the image in the world coordinate system based on the sensor information. For example, when the sensor is a gyro sensor, the coordinate processing unit 136 calculates the coordinates of each pixel in the world coordinate system based on the posture of the image capturing device indicated by the sensor information.

The search processing unit 131c of the search unit 131 searches for the target object included in the image based on the coordinates of the target object included in the drawing information. Since the coordinate systems have been integrated into the same coordinate system as above, the search processing unit 131c is capable of searching for the target object included in the image based on the drawing information.

Further, when position information on the target object (e.g., screw) is included in the drawing information, the search processing unit 131c may transform the position information into that in the world coordinate system and search for the target object (e.g., screw) included in the image based on the transformed position information.

The search processing unit 131c searches for the target object included in the image based on the image.

The search processing unit 131c calculates an error by comparing the position of the target object found by the search based on the drawing information with the position of the target object found by the search based on the image. When the error is less than a threshold value, the determination unit 131d outputs the search result based on the image. When the error is greater than or equal to the threshold value, the determination unit 131d may determine the average of the position of the target object found by the search based on the drawing information and the position of the target object found by the search based on the image as the search result regarding the image. As above, when the search result regarding the image is undesirable, the image processing device 100d adjusts the search result regarding the image. Accordingly, the image processing device 100d makes the analysis of the sharpness and the like in regard to the region indicated by the adjusted search result. Thus, the image processing device 100d is capable of making an appropriate analysis.

The search unit 131 outputs the search result and coordinate information while linking (associating) them with each other.

When the judgment unit 135 judges that the image is appropriate as an image used for the test, the judgment unit 135 outputs the analysis result, the image and the coordinate information while linking (associating) them together.

Next, the output control unit 150d will be described in detail below.

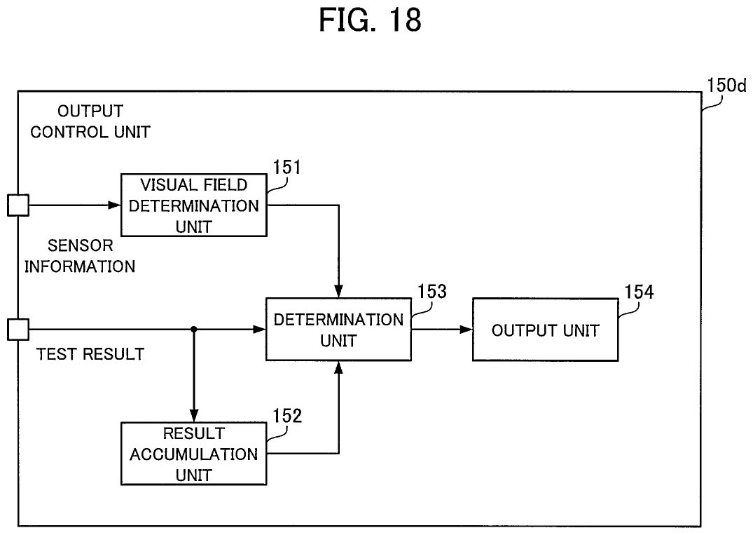

FIG. 18 is a block diagram showing functions of the output control unit in the sixth embodiment. The output control unit 150d includes a visual field determination unit 151, a result accumulation unit 152, a determination unit 153 and an output unit 154.

The visual field determination unit 151 determines a visual field of the worker and a visual field region based on the sight line information indicated by the sensor information.

The result accumulation unit 152 accumulates the test results. When a predetermined number is exceeded, the test results are deleted one by one in chronological order.

The determination unit 153 may determine whether or not to provide the test result to the worker. When the test result is provided to the worker, the determination unit 153 determines provision timing. For example, the determination unit 153 detects whether the worker is performing work or not based on the information determined by the visual field determination unit 151 and determines the provision timing based on the result of the detection.

When the test result this time and the test result in the past differ from each other, the determination unit 153 determines to output the test result this time. In short, the determination unit 153 executes control so as to output the test result when the test result changes. The display content switches frequently, thus situations in which the worker cannot recognize the display content are prevented.

The determination unit 153 may determine to output the test result this time and the test result in the past at the same time. For example, in a case where the test target object in the past is a screw A and the test target object this time is a screw B, the determination unit 153 determines to output the test result of the screw A and the test result of the screw B at the same time.

The determination unit 153 determines to where the analysis result should be outputted. For example, the determination unit 153 determines to output the analysis result to a display viewed by the worker. Further, the determination unit 153 may determine to display the analysis result in a peripheral part of the screen of the display in a list format. When the output target is a head-mounted Mixed Reality (MR) device of the see-through type, the determination unit 153 may identify the target object based on the coordinate information and determine to superimpose the analysis result on the target object by the superimposition display method.

The output unit 154 outputs the analysis result according to the results of the determination by the determination unit 153. Further, the output unit 154 may output information indicating whether or not all of the test target objects included in the drawing information have been tested. Furthermore, the output unit 154 may output information on each target object indicated by the drawing information and a 3D model of each target object.

In the first to sixth embodiments, the description was given of cases where the composition, the luminance and the sharpness are analyzed. It is permissible even if at least one of the composition, the luminance and the sharpness is analyzed. Incidentally, the at least one of the composition, the luminance and the sharpness is referred to also as the analysis target.

In the modification of the first embodiment, a description was given of the case where the analyzing learned model is used. The analyzing learned model may be used in the second to sixth embodiments. When the analyzing learned model is used, the analyzing learned model has the same function as the analysis generation unit in the second to sixth embodiments.

Features in the embodiments described above can be appropriately combined with each other.

### DESCRIPTION OF REFERENCE CHARACTERS

100, 100a, 100b, 100c, 100d: image processing device, 101: processor, 102: volatile storage device, 103: nonvolatile storage device, 110: storage unit, 120, 120c, 120d: acquisition unit, 130, 130c, 130d: analysis generation unit, 131: search unit, 131a: image accumulation unit, 131b: search result accumulation unit, 131c: search processing unit, 131d: determination unit, 132: composition analysis unit, 133: lighting environment analysis unit, 134: sharpness analysis unit, 135, 135a: judgment unit, 135b: result accumulation unit, 135c: determination unit, 136: coordinate processing unit, 140, 140c: testing unit, 150, 150d: output control unit, 151: visual field determination unit, 152: result accumulation unit, 153: determination unit, 154: output unit, 160: provision unit, 170: image capturing control unit, 171: exposure adjustment unit, 172: focus adjustment unit, 173: composition control unit, 180, 180c: correction unit, 200: image capturing device

1. An image processing device comprising:
acquiring circuitry to acquire an image and a testing learned model for testing a target object of a test:
analysis generating circuitry to analysis whether the target object is included in the image or not by using the image and generate an analysis result indicating that the image is appropriate as an image used for the test when the target object is included in the image; and
testing circuitry to test the target object included in the image by using the image and the testing learned model when the analysis result indicates that the image is appropriate as an image used for the test.

2.-17. (canceled)

18. An image processing device comprising:
acquiring circuitry to acquire a testing learned model for testing a target object of a test and a plurality of images obtained by successively photographing the target object:
analysis generating circuitry to analysis whether the target object is included in the image or not by using an image that has not undergone the search among the plurality of images and generate an analysis result indicating that the image is appropriate as an image used for the test when the target object is included in the image; and
testing circuitry to test the target object included in the image by using the image and the testing learned model when the analysis result indicates that the image is appropriate as an image used for the test,
wherein
the analysis generating circuitry includes:
an image accumulation storage to accumulate past images as images that have undergone the search for the target object among the plurality of images;
a search result accumulation storage to accumulate a search result regarding each past image;
search processing circuitry to search for the target object in a present image as the image that has not undergone the search; and
determining circuitry to determine a search result based on a position of the target object in the present image and a position of the target object in the past image when an error between the position of the target object in the present image and the position of the target object in the past image is greater than or equal to a predetermined threshold value based on the past image, the search result regarding the past image and a search result regarding the present image.

19. The image processing device according to claim 18, wherein the determining circuitry determines an average of a position of the target object in the present image and a position of the target object in the past image as the search result regarding the present image when the error between the position of the target object in the present image and the position of the target object in the past image is greater than or equal to the threshold value based on the past image, the search result regarding the past image and the search result regarding the present image.

20. The image processing device according to claim 18, wherein when the target object is included in the image, based on a region, as a region corresponding to the target object, in the image, the analysis generating circuitry analyzes an analysis target as at least one of composition regarding the target object, luminance of the region and sharpness of the region, and generates the analysis result indicating that the image is appropriate as an image used for the test when the image is appropriate as an image used for the test based on result of the analysis of the analysis target.

21. The image processing device according to claim 20, further comprising providing circuitry, wherein
the analysis result includes the result of the analysis of the analysis target, and
the providing circuitry provides information for generating an appropriate image based on the analysis result.

22. The image processing device according to claim 18, further comprising image capturing control circuitry to control an image capturing device based on the analysis result so as to make the image capturing device generate an appropriate image.

23. The image processing device according to claim 18, wherein
the acquiring circuitry acquires sensor information as information obtained by detection by a sensor, and
the analysis generating circuitry analyzes whether the target object is included in the image or not based on the sensor information and the image.

24. The image processing device according to claim 23, wherein when the target object is included in the image, based on the sensor information and a region, as a region corresponding to the target object, in the image, the analysis generating circuitry analyzes an analysis target as at least one of composition regarding the target object, luminance of the region and sharpness of the region.

25. The image processing device according to claim 23, further comprising correcting circuitry to correct the image by using the sensor information.

26. The image processing device according to claim 18, wherein
the acquiring circuitry acquires sensor information as information obtained by detection by a sensor and drawing information including the target object, and
the analysis generating circuitry includes:
coordinate processing circuitry to integrate a coordinate system of the drawing information and a coordinate system of the image by using the image, the sensor information and the drawing information:
search processing circuitry to search for the target object included in the image based on coordinates of the target object included in the drawing information and searches for the target object included in the image based on the image; and
determining circuitry to determine an average of a position of the target object found by the search based on the drawing information and a position of the target object found by the search based on the image as a search result regarding the image when an error between the position of the target object found by the search based on the drawing information and the position of the target object found by the search based on the image is greater than or equal to a predetermined threshold value.

27. The image processing device according to claim 18, wherein
based on a region, as a region corresponding to the target object, in the present image, the analysis generating circuitry analyzes an analysis target as at least one of composition regarding the target object, luminance of the region and sharpness of the region, and
the analysis generating circuitry includes:
judging circuitry to judge whether the present image is appropriate as an image used for the test or not based on the analysis target:
a result accumulation storage to accumulate past judgment results indicating whether or not each past image is appropriate as an image used for the test; and
determining circuitry to make a decision by majority based on the past judgment result and a present judgment result indicating whether the present image is appropriate as an image used for the test or not when the past judgment result and the present judgment result do not coincide with each other, and then determines a judgment result based on the decision by majority as the present judgment result.

28. The image processing device according to claim 18, further comprising image capturing control circuitry to control an image capturing device so that the image capturing device generates a plurality of images with different exposures, different focuses and different compositions, wherein
the acquiring circuitry acquires the plurality of images, and
for each of the plurality of images, the analysis generating circuitry analyzes whether or not the image is appropriate as an image used for the test.

29. The image processing device according to claim 18, further comprising correcting circuitry, wherein
the acquiring circuitry acquires a plurality of images obtained by successively photographing the target object,
the analysis generating circuitry generates an analysis result regarding a first image among the plurality of images, and
the correcting circuitry corrects a second image, as one image among the plurality of images and an image generated immediately after the first image, based on the analysis result regarding the first image.

30. The image processing device according to claim 18, wherein
the acquiring circuitry acquires a plurality of images obtained by successively photographing the target object and sensor information indicating movement of an image capturing device that generated the plurality of images detected by a sensor,
the analysis generating circuitry includes:
a search result accumulation storage to accumulate search results regarding a first image among the plurality of images;
search processing circuitry to search for the target object in a second image as one image among the plurality of images and an image generated immediately after the first image, determines a present position of the image capturing device based on the movement of the image capturing device indicated by the sensor information, calculates a difference between a past position of the image capturing device determined based on the sensor information acquired the previous time and the present position of the image capturing device, and determines a present position of the target object based on the search result regarding the first image and the difference; and
determining circuitry to determine an average of a position of the target object in the second image and the present position of the target object as a search result regarding the second image when an error between the position of the target object in the searched second image and the present position of the target object is greater than or equal to a predetermined threshold value.

31. The image processing device according to claim 18, wherein
the acquiring circuitry acquires an analyzing learned model for inferring whether the image is appropriate as an image used for the test or not, and
the analysis generating circuitry analyzes whether the image is appropriate as an image used for the test or not by using the image and the analyzing learned model.

32. The image processing device according to claim 18, further comprising output controlling circuitry to output a test result.

33. An image processing method performed by an image processing device, the image processing method comprising:
acquiring a testing learned model for testing a target object of a test and a plurality of images obtained by successively photographing the target object:
analyzing whether the target object is included in the image or not by using an image that has not undergone the search among the plurality of images;
generating an analysis result indicating that the image is appropriate as an image used for the test when the target object is included in the image;
testing the target object included in the image by using the image and the testing learned model when the analysis result indicates that the image is appropriate as an image used for the test; and
when a search result of the search by performing the analysis of a present image as the image is determined and when an error between a position of the target object in the present image and a position of the target object in a past image is greater than or equal to a predetermined threshold value based on the past image, the search result regarding the past image and a search result regarding the present image, determining the search result based on the position of the target object in the present image and the position of the target object in the past image.

34. An image processing device comprising:
a processor to execute a program; and
a memory to store the program which, when executed by the processor, performs processes of,
acquiring a testing learned model for testing a target object of a test and a plurality of images obtained by successively photographing the target object,
analyzing whether the target object is included in the image or not by using an image that has not undergone the search among the plurality of images,
generating an analysis result indicating that the image is appropriate as an image used for the test when the target object is included in the image,
testing the target object included in the image by using the image and the testing learned model when the analysis result indicates that the image is appropriate as an image used for the test, and
when a search result of the search by performing the analysis of a present image as the image is determined and when an error between a position of the target object in the present image and a position of the target object in a past image is greater than or equal to a predetermined threshold value based on the past image, the search result regarding the past image and a search result regarding the present image, determining the search result based on the position of the target object in the present image and the position of the target object in the past image.
